(19) United States
(12) Patent Application Publication
(10) Pub. No.: US 2010/0014098 A1
(43) Pub. Date: Jan. 21, 2010

(54) Oblique incidence interferometer

(75) Inventors: Yoshimasa Suzuki, Tsukuba-shi (JP); Reiya Ootao, Tsukuba-shi (JP)

Correspondence Address: OLIFF & BERRIDGE, PLC, P.O. BOX 320850, ALEXANDRIA, VA, 22320-4850, US

(73) Assignee: MITUTOYO CORPORATION, KAWASAKI (JP)

(21) Appl. No.: 12/458,592

(22) Filed: Jul. 16, 2009

(30) Foreign Application Priority Data
Jul. 18, 2008 (JP) 2008-186967

(51) Int. Cl. G01B 9/02

(52) U.S. Cl. 356/512

(57) ABSTRACT

An oblique incidence interferometer enlarges a measurement range without increasing a size of the apparatus. The oblique incidence interferometer includes a light source for emitting coherent light in an oblique direction to a measurement object; a light collimating unit for collimating the coherent light from the light source; a beam dividing unit for dividing the collimated beam from the light collimating unit into a measurement beam and a reference beam; a beam combining unit for combining the measurement beam reflected by the measurement object with the reference beam; and an image pickup device for picking up images of interference fringes representing a surface shape of the measurement object. The oblique incidence interferometer also includes a measurement range expanding device for enlarging a light measurement range on the measurement object in a lateral direction of the measurement range.

### BACKGROUND

The present invention relates to an oblique incidence interferometer.

Oblique incidence interferometers measure a shape of a measurement objective surface by irradiating the measurement objective surface with coherent light in an oblique direction and analyzing interference fringes produced by interference between a measuring beam reflected from the measurement objective surface and a reference beam.

FIG. 10 shows a conventional oblique incidence interferometer 100. The oblique incidence interferometer 100 includes a light source 101, a lens 102, a collimator lens 103, a beam dividing element 104, a beam combining element 105, a lens 106, and an image pickup device 107.

A beam emitted from the light source 101 enters the beam dividing element 104 via the lens 102 and the collimator lens 103 to be divided into two beams. One of the divided beams is irradiated to the surface H of measurement object W in an oblique direction. Then, the light reflected from the surface H of the measurement object W is combined by the beam combining element 105 with the other beam divided by the beam dividing element 104. The combined beam is fed to the image pickup device 107 and images are picked up on the image pickup device 107 as interference fringe images.

FIG. 11 shows a measurement range of the oblique incidence interferometer 100. In FIG. 11, a condition is assumed wherein a laser beam (beam diameter: dx) is obliquely incident on a measurement objective surface H of the measurement object W at an angle θ to a normal of the measurement objective surface H. In this case, the measurement range of the measurement objective surface H is an elliptic irradiation region that is enlarged I/cos θ times in a longitudinal direction (X-direction in FIG. 11) of the measurement range. That is, in the measurement region (Dx, Dy), the following equations are satisfied: Dx=dx/cos θ, Dy=dx. Accordingly, the measurement range of the oblique incidence interferometer is enlarged in the longitudinal direction in accordance with the incident angle θ of the laser beam.

For background information see, for example, Japanese Unexamined Laid-Open Patent Application Publication No. 2008-32690.

### SUMMARY

The measurement region of the oblique incidence interferometer described above does not vary in a lateral direction (Y-direction in FIG. 11) even when the incident angle θ changes. Hence, in order to also enlarge the measurement range in the lateral direction, for production of a collimated beam with a larger diameter, arrangement of a collimator lens with a large diameter is required by enlarging a distance from a light source, causing a problem in that the size of the apparatus increases.

It is an object of the present invention to provide an oblique incidence interferometer capable of enlarging a measurement range also in the lateral direction of the range without increasing the size of the apparatus.

In order to address the problems described above, an oblique incidence interferometer includes a light source configured to emit coherent light in an oblique direction to a measurement object. A light collimating unit is included and configured to collimate the coherent light from the light into a collimated beam. A beam dividing unit is configured to divide the collimated beam from the light collimating unit into a measurement beam and a reference beam and a beam combining unit is configured to combine the measurement beam reflected by the measurement object with the reference beam. An image pickup device is configured to pick up images of interference fringes representing a surface shape of the measurement object. A measurement range expanding means is included for enlarging a light measurement range on the measurement object in a lateral direction of the measurement range.

The measurement range expanding means may include an optical path shift member arranged between the light collimating unit and the beam dividing unit for moving parallel to a proceeding direction of the coherent light by causing the coherent light from the light source to pass through the optical path shift member. A drive unit configured to rotate the optical path shift member is included with a controlling means that causes the image pickup device to integrally receive images of interference fringes of an irradiation region. The irradiation region continuously moves parallel, for a period of time longer than a moving cycle of the optical path shift member, by continuously rotating the optical path shift member to continuously move parallel to the irradiation region on the measurement object in a lateral direction of the irradiation region.

The drive unit may be configured to rotatively reciprocate the optical path shift member by a predetermined angle.

The drive unit may also be configured to continuously rotate the optical path shift member in one direction.

The oblique incidence interferometer may further include a shutter configured to be opened/closed according to the rotation angle of the optical path shift member. The controlling means is configured to cause the image pickup device to selectively and integrally receive images of the interference fringes of the irradiation region, which continuously moves parallel, by controlling the opening/closing of the shutter.

The measurement range expanding means of the oblique incidence interferometer may include a beam diameter enlarging member, which is arranged between the light collimating unit and the beam dividing unit, and causes the coherent light from the light source to pass through the beam diameter enlarging member to enlarge a diameter of the coherent light only in one direction.

The beam diameter enlarging member may be an anamorphic prism.

By providing the measurement range expanding means in the oblique incidence interferometer wherein the measurement object is irradiated with light in an oblique direction, the beam measurement range on the measurement object can be expanded in a lateral direction of the measurement range, without increasing the size of the apparatus.

### BRIEF DESCRIPTION OF THE DRAWINGS

FIG. 1 illustrates an oblique incidence interferometer according to a first embodiment.

FIG. 2 illustrates a block diagram of the measurement range enlarging means of the oblique incidence interferometer illustrated in FIG. 1.

FIG. 3 illustrates an enlarged view of an optical path shift member according to the first embodiment.

FIG. 4 illustrates the relationship between an optical path shift member of the oblique incidence interferometer illustrated in FIG. 1 and an irradiation region on a measurement object.

FIG. 5 is a drawing illustrating a state wherein light enters the optical path shift member at an incident angle θ.

FIG. 6 is a graph showing the relationships among thickness t, the incident angle θ, and a shift amount S of the optical path shift member.

FIGS. 7(a)-7(c) show a relationship between the optical path shift member of an oblique incidence interferometer according to a second embodiment and the irradiation region on the measurement object.

FIG. 8 is a block diagram illustrating measurement range expanding means of the oblique incidence interferometer according to the second embodiment illustrated in FIGS. 7(a)-7(c).

FIG. 9 illustrates a relationship between a beam diameter enlarging member of an oblique incidence interferometer according to a third embodiment and the irradiation region on the measurement object.

FIG. 10 illustrates a conventional oblique incidence interferometer.

FIG. 11 illustrates a measurement range of an oblique incidence interferometer.

### DETAILED DESCRIPTION OF EMBODIMENTS

Exemplary embodiments of an oblique incidence interferometer according to the present invention will be described below with reference to the drawings.

### First Embodiment

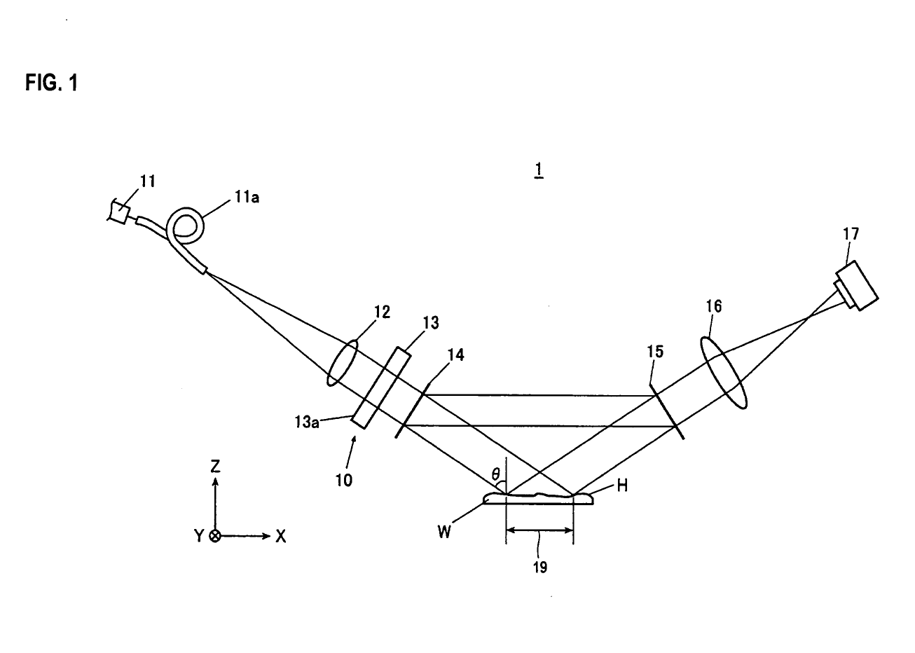

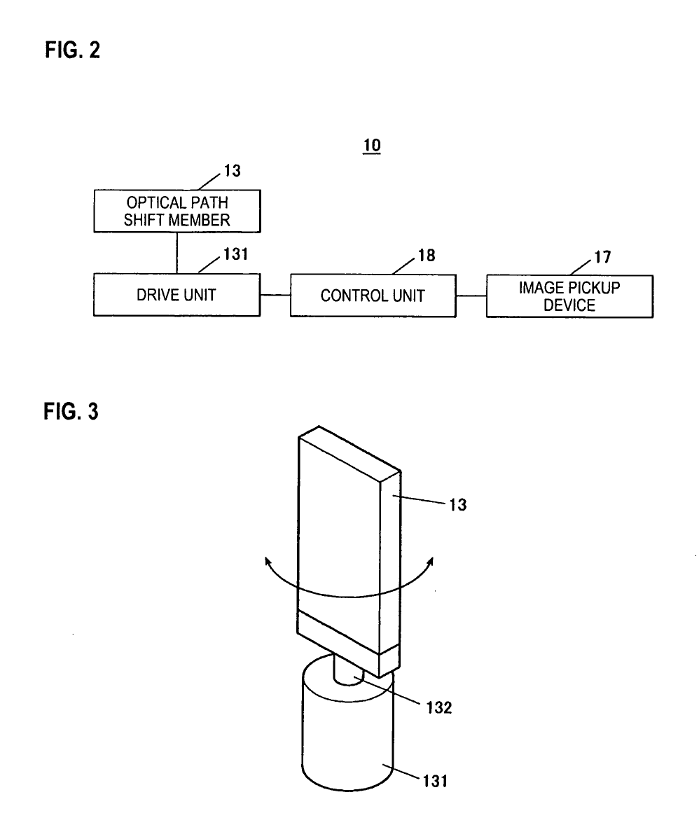

FIG. 1 illustrates an oblique incidence interferometer 1 according to a first embodiment; FIG. 2 is a block diagram illustrating measurement range enlarging means 10 of the oblique incidence interferometer 1; and FIG. 3 illustrates an enlarged view of an optical path shift member 13 according to the first embodiment.

In the following description of the oblique incidence interferometer 1, a substantially vertical direction to the measurement objective surface H of the measurement object W is assumed to be in a Z-direction and two directions perpendicular to the Z-direction are assumed to be in an X-direction and in a Y-direction.

As illustrated in FIG. 1 the oblique incidence interferometer 1 includes a light source 11, a light collimating unit 12, an optical path shift member 13, a beam dividing unit 14, a beam combining unit 15, a lens 16, and an image pickup device 17.

The oblique incidence interferometer 1 also includes measurement range enlarging means 10 for enlarging the light measurement range on the measurement object W in a lateral direction of the measurement range. As illustrated in FIG. 2, the measurement range enlarging means 10 may include the optical path shift member 13, a drive unit 131, the image pickup device 17, and a control unit 18.

The light source 11 emits coherent light, such as a laser beam, in an oblique direction relative to the measurement object W. The light source 11 may use a laser source outputting laser light, such as an He—Ne laser, having favorable coherence. The light emitted from the light source 11 is caused to expand with an N.A. of about 0.1 and enter the light collimating unit 12 via an optical fiber 11a.

The light collimating unit 12 is a collimator lens, for example, configured to collimate the coherent light from the light source 11 to have a larger beam diameter. The light emitted from the light source 11 is collimated by the light collimating unit 12 into a collimated beam and then, enters the beam dividing unit 14 via an optical path shift member 13 (described later).

The beam dividing unit 14 is configured to divide the collimated beam or incident parallel light that has passed through the optical path shift member 13 from the light collimating unit 12 into two beams. The beam dividing unit 14 may use a beam splitter or a diffraction grating, for example. With one beam of the two beams divided by the beam dividing unit 14, the measurement objective surface H of the measurement object W is irradiated. The beam is referred to as a measurement beam. The measurement beam is reflected from the measurement objective surface H to enter the beam combining unit 15.

The other beam of the two beams divided by the beam dividing unit 14 enters the beam combining unit 15. The second beam is referred to as a reference beam serving as a measurement reference.

The optical path shift member 13 is arranged in the optical path between the light collimating unit 12 and the beam dividing unit 14, and is formed of optical glass having parallel planar surfaces, for example. As illustrated in FIG. 3, the optical path shift member 13 includes a rotatable shaft 132 and a drive unit 131 for rotating the rotatable shaft 132 arranged at one end of the optical path shift member 13. The optical path shift member 13 continuously reciprocates rotatively by a predetermined angle in synchronization with the rotation of the rotatable shaft 132.

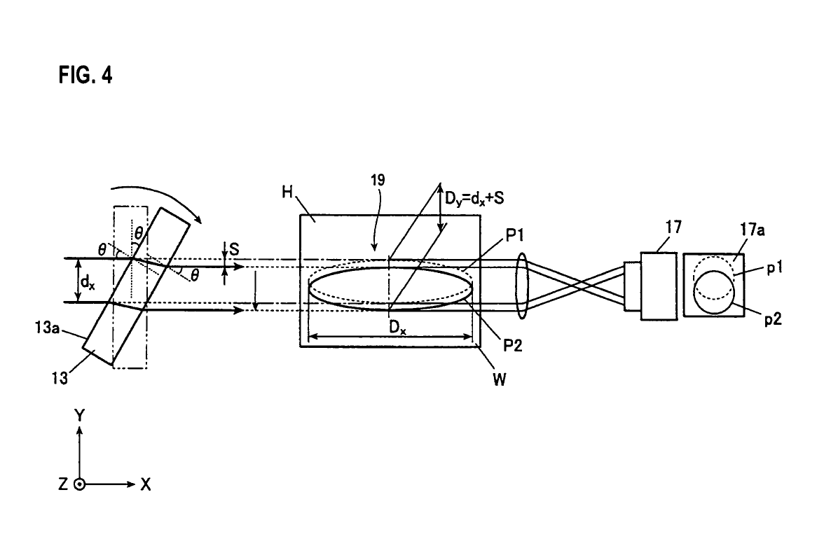

The incident parallel light in the optical path shift member 13 from the light collimating unit 12 is periodically refracted in the optical path by passing through the continuously rotatively reciprocating optical path shift member 13, so that the irradiation region 19 of the measurement beam, with which the measurement object W is irradiated, is to be parallel shifted periodically in the lateral direction of the irradiation region 19 by a shift amount S (shown in FIG. 4). That is, the optical path shift member 13 causes coherent light from the light source 11 to parallel shift the proceeding direction of the coherent light.

The drive unit 131 may be a galvanometer or a motor, for example, and is driven based on a control signal from the control unit 18 to rotatively reciprocate the optical path shift member 13 by a predetermined angle.

FIG. 4 illustrates the relationship between the optical path shift member 13 and the irradiation region 19 (P1 and P2) on the measurement object W. In FIG. 4, the beam dividing unit 14 and the beam combining unit 15 are omitted.

As illustrated in FIG. 4, when the light (beam diameter: dx) from the light collimating unit 12 enters an incidence planar surface 13a of the optical path shift member 13 at an incident angle of 0°, the light proceeds straight to be divided by the beam dividing unit 14. The measurement object W is irradiated at a position P1 on the measurement object W with the measurement beam. The images are picked up as interference fringe images at a position p1 on an imaging plane 17a of the image pickup device 17.

When the optical path shift member 13 is rotated by an angle of θ° so that the light from the light collimating unit 12 enters the incidence planar surface 13a at an incident angle θ°, the light is refracted when the light enters the optical path shift member 13 and is emitted from the shift member 13 with a shift amount S in the Y-direction. The light emitted from the optical path shift member 13 is divided by the beam dividing unit 14, and the measurement object W is irradiated with the measurement beam at a position P2 on the measurement object W, so that the images are picked up as interference fringe images at a position p2 on the imaging plane 17a of the image pickup device 17.

A method for calculating the shift amount S will now be described in detail.

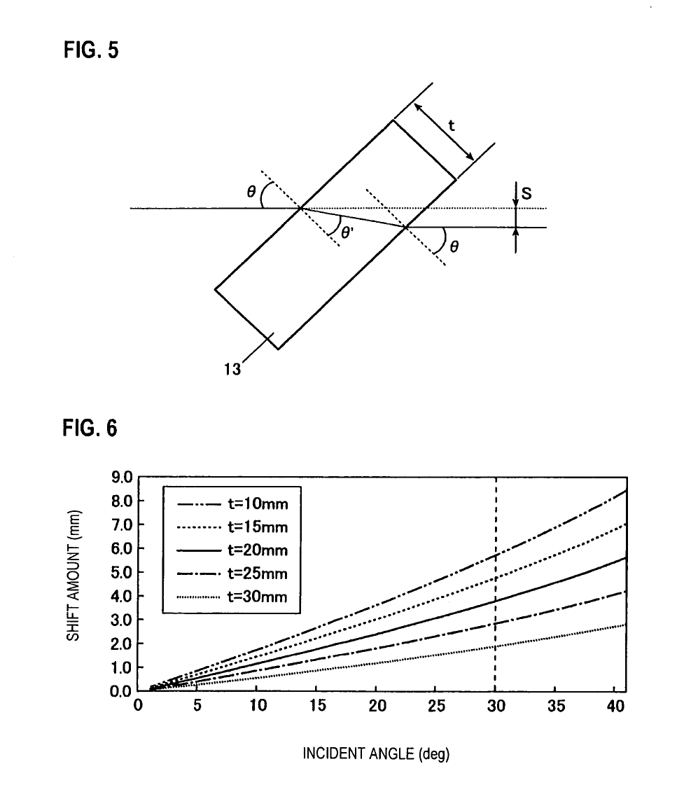

FIG. 5 illustrates a state wherein light enters the optical path shift member 13 at an incident angle θ, where the refractive index of the optical path shift member 13 is denoted as n and thickness of the applied path shift member 13 is denoted as t.

As illustrated in FIG. 5, the rule sin θ=n sin θ′ (Snell's law) holds between the light incident in the optical path shift member 13 and the transmitted light that has passed through the optical path shift member 13. Accordingly, the transmitted light is displaced in parallel from the incident light by the shift amount S expressed by the following equation (1).

$$\begin{matrix}Numerical Formula 1 & \\ S = t sin θ ( 1 - \frac{cos θ}{\sqrt{{n}^{2} - {sin}^{2} θ}} ) & ( 1 )\end{matrix}$$

FIG. 6 is a graph showing the relationship between the thickness t, the incident angle θ, and the shift amount S of the optical path shift member 13. In FIG. 6, the shift amount (mm) is plotted in ordinates and the incident angle (deg) in abscissa. Upon measuring data of FIG. 6, the refractive index n=1.5 is used, which is the reflective index for general glass. Also, the light cannot enter the optical path shift member 13 at an angle of over 41° because of a critical angle during emission.

It is understood from FIG. 6 that by increasing the incident angle θ, the shift amount S increases. Also, when the incident angle θ remains constant, it is understood that by increasing the thickness t, the shift amount S increases. For example, when the incident angle θ is 30°, the shift amount S is about 1.9 mm at t=10 mm; about 3.8 mm at t=20 mm; and about 5.8 mm at t=30 mm. At other angles, with increasing thickness t, the shift amount S increases, in the same way.

The beam combining unit 15 combines the measurement beam reflected from the measurement objective surface H with the reference beam. The beam combining unit 15 is formed of a beam splitter, for example, in the same way as the beam dividing unit 14, to form interference fringes by combining the measurement beam with the reference beam.

The interference fringes formed by the beam combining unit 15 are focused by the lens 16, so that the images of the interference fringes representing the surface shape of the measurement object W are picked up by the image pickup device 17. Specifically, the image pickup device 17 integrally receives images of the interference fringes on the irradiation region 19, which continuously moves parallel, for a period longer than the moving cycle of the optical path shift member 13.

FIG. 2 illustrates a block diagram of the measurement range enlarging means 10 of the oblique incidence interferometer illustrated in FIG. 1. The control unit 18 may include a CPU (central processing unit), an ROM (read only memory), and an RAM (random access memory)(not shown). The control unit 18, as illustrated in FIG. 2, is connected to the drive unit 131 and the image pickup device 17.

The ROM of the control unit 18 stores a control program for controlling the drive unit 131 and the image pickup device 17 and various processing programs, and the CPU exercises control over operations of the drive unit 131 and the image pickup device 17 in cooperation with the control program and various processing programs.

For example, the control unit 18 may function as control means for continuously moving the irradiation region 19 on the measurement object W in parallel in the lateral direction of the irradiation region 19 by continuously rotating the optical path shift member 13, so that the image pickup device 17 integrally receives images of the interference fringes on the irradiation region 19, which continuously moves parallel, for a period longer than the moving cycle of the optical path shift member 13.

Specifically, the control unit 18 may rotatively reciprocate the optical path shift member 13 by a predetermined angle at a high speed by driving the drive unit 131.

The control unit 18 also causes the image pickup device 17 to integrally receive images of the interference fringes, which moves on the image pickup device 17 at high speed to follow the reciprocation of the irradiation range on the measurement object W, for a period adequately longer than the moving cycle based on a moving frequency. For example, when the interference fringes reciprocate at a frequency of 1 kHz, the image pickup device 17 integrally receives images for a period of about over ten times the frequency (0.01 sec).

The control unit 18 may also execute computing processing to have the surface shape of the measurement object W based on the interference fringe images obtained by receiving the images with the image pickup device 17.

An analyzing method for numerically analyzing the obtained interference fringes may include a Fourier analysis method and a phase shift method.

The function of the oblique incidence interferometer 1 configured in such a manner will be described.

The light emitted from the light source 11 is periodically refracted in accordance with rotation of the optical path shift member 13 by passing the light through the continuously rotating optical path shift member 13. The optical path shift member 13, emits light with an optical path having been periodically moved by the shift amount S.

On the measurement objective surface H of the measurement object W, the light with an optical path having been periodically moved by the shift amount S is emitted, so that the irradiation region 19 is also moved parallel continuously. That is, the irradiation region 19 reciprocates in parallel in the lateral direction.

Accordingly, on the imaging plane 17a of the image pickup device 17, the interference fringes moving at high speed emerge to follow the reciprocation of the irradiation range on the measurement object W and these interference fringe images are integrally received by the image pickup device 17.

As described above, according to the oblique incidence interferometer 1 of the first embodiment, by reciprocating parallel the irradiation region 19 on the measurement object W of the measurement beam in the lateral direction, the image pickup device 17 is caused to integrally receive images of the interference fringes moving on the image pickup device 17 at high speed to follow the reciprocation of the irradiation range. The beam measurement range (Dx, Dy) on the measurement object W becomes Dx=dx/cos θ, Dy=dx+S, so that the measurement range is effectively enlarged. Hence, without expanding the apparatus in size, the measurement range can be enlarged.

Also, by providing the optical path shift member 13 between the light collimating unit 12 and the beam dividing unit 14, the beam measurement range on the measurement object W can be enlarged also in the lateral direction of the measurement range while maintaining a distance between the light source 11 and the light collimating unit 12, so that the measurement range can be enlarged without increasing a size of the apparatus.

### Second Embodiment

The second embodiment of the present invention will be described focusing mainly on points by which it is different from the first embodiment. Like reference numerals designate like components common to the first embodiment and the description thereof is omitted.

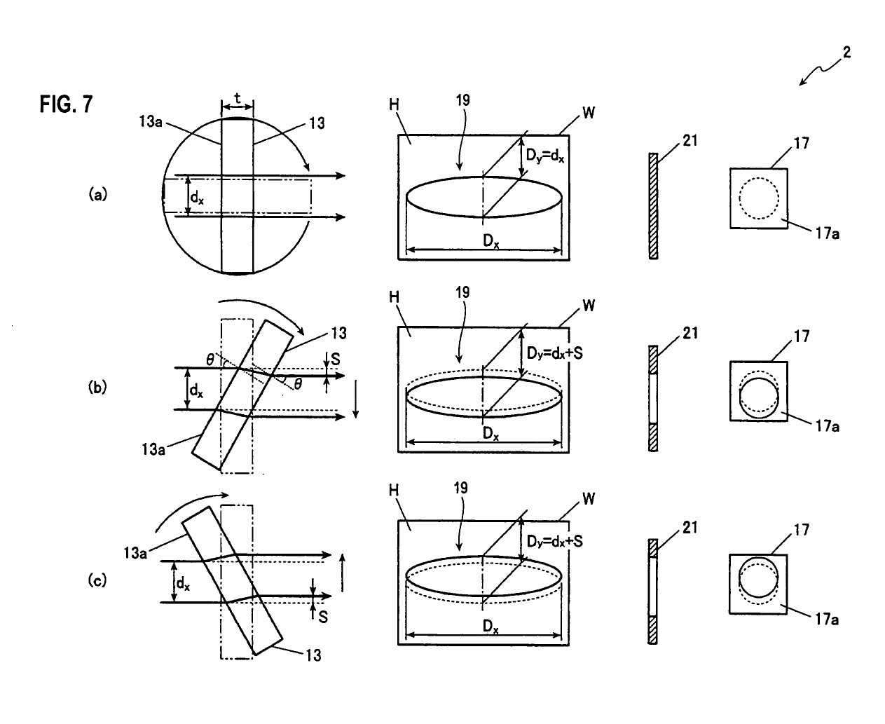

FIGS. 7(a)-7(c) show a relationship between the optical path shift member 13 of an oblique incidence interferometer 2 according the second embodiment and the irradiation region 19 on the surface H of the measurement object W. In FIGS. 7(a)-7(c), the beam dividing unit 14 and the beam combining unit 15 are omitted.

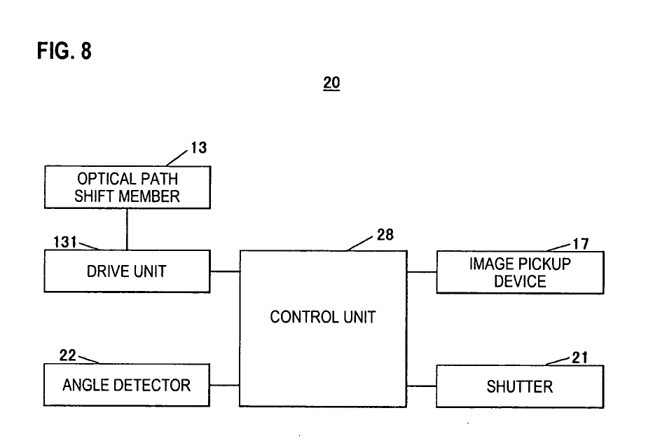

FIG. 8 illustrates a block diagram illustrating measurement range expanding means 20 of the oblique incidence interferometer 2 according to the second embodiment.

The measurement range expanding means 20 of the oblique incidence interferometer 2 illustrated in FIG. 8, includes the optical path shift member 13, the drive unit 131, the image pickup device 17, a shutter 21, an angle detector 22, and a control unit 28.

As illustrated in FIGS. 7(a)-7(c), the shutter 21 is arranged on an optical axis directly in front of the image pickup device 17 and is opened/closed in accordance with the angle of rotation of the optical path shift member 13. The angle detector 22 is formed of an encoder, for example, to produce a pulse signal per every rotation of the optical path shift member 13 by a predetermined angle. The control unit 28 drives a rotation shaft 132 (shown in FIG. 3) by controlling the drive unit 131 to rotate the optical path shift member 13 in one direction at predetermined high speed. The control unit 28 opens/closes the shutter 21 in synchronization with the pulse signal produced by the angle detector 22 to cause the image pickup device 17 to integrally and selectively receive images of the interference fringes of the irradiation region 19 continuously moving parallel.

Specifically, while the light (beam diameter: dx) from the light collimating unit 12 enters the incidence planar surface 13a of the optical path shift member 13 at an incident angle within a predetermined range of 0° to θ° to move parallel, the control unit 28 opens the shutter 21 (see FIGS. 7(b) and 7(c)).

On the other hand, while the light from the light collimating unit 12 enters the incidence planar surface 13a of the optical path shift member 13 at an incident angle out of the predetermined range, the control unit 28 closes the shutter 21 (see FIG. 7(a)).

The control unit 28 may also cause the image pickup device 17 to pick up images of the interference fringes of the irradiation region 19 only at instances of the rotation of the optical path shift member 13 by a predetermined angle in synchronization with the pulse signal produced by the angle detector 22.

As described above, according to the oblique incidence interferometer 2 of the second embodiment, since the irradiation region 19 on the measurement object W can be moved in parallel in both positive and negative directions, the measurement range (Dx, Dy) satisfies equations of Dx=dx/cos θ, Dy=dx+2S, so that the measurement range is even further enlarged in the lateral direction.

Also, by receiving no image unless the optical path shift member 13 moves parallel due to a position of the optical path shift member 13, contrast of the interference fringes can be improved.

Also, since the optical path shift member 13 can rotate in one direction, the mechanism is simplified to be able to rotate at high speed.

### Third Embodiment

The third embodiment of the present invention will be described focusing mainly on points by which it is different from the first embodiment. Like reference numerals designate like components common to the first embodiment and the description thereof is omitted.

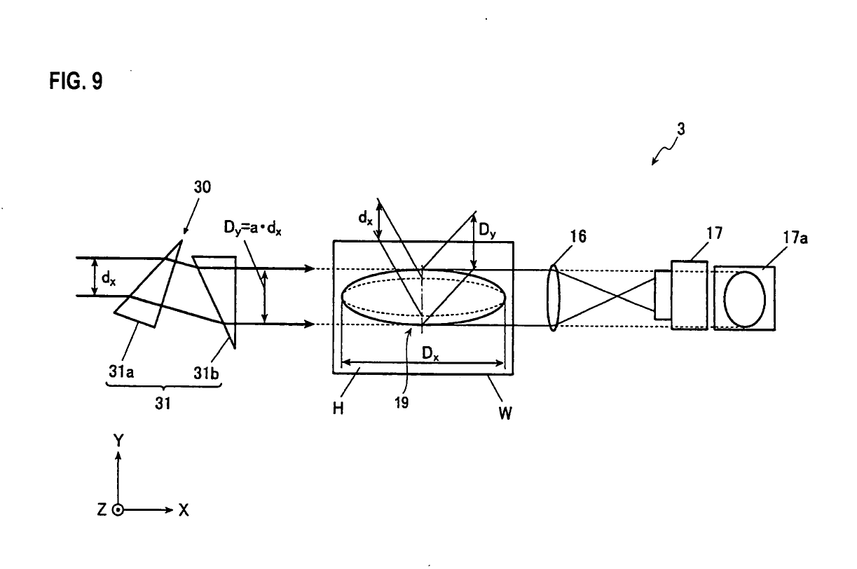

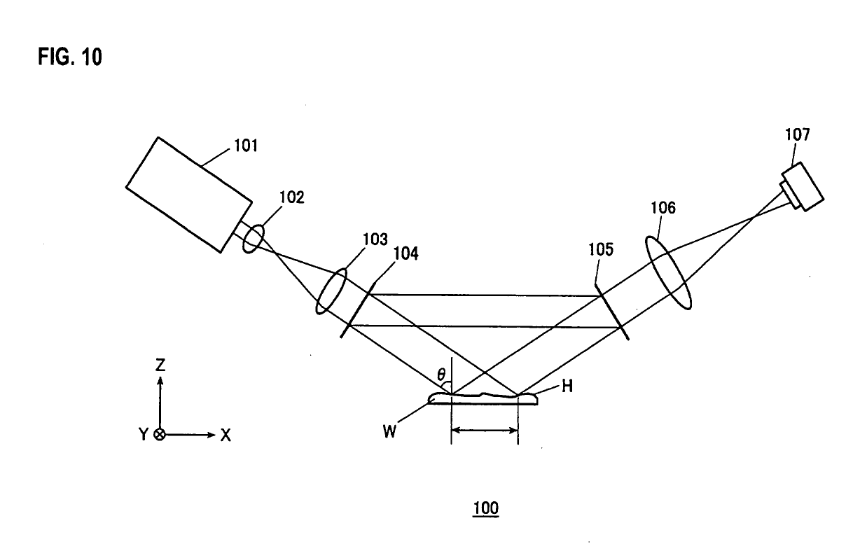

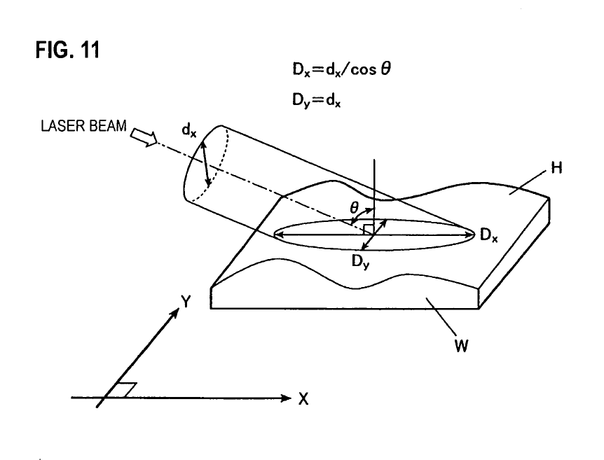

FIG. 9 shows a relationship between a beam diameter enlarging member 31 of an oblique incidence interferometer 3 and an irradiation region 19 on the surface H of the measurement object W. In FIG. 9, the beam dividing unit 14 and the beam combining unit 15 are omitted.

Measurement range enlarging means 30 of the oblique incidence interferometer 3 is the beam diameter enlarging member 31 wherein coherent light from the light source 11 is passed through the beam diameter enlarging member 31 to enlarge the diameter of the coherent light only in one direction.

The beam diameter enlarging member 31 may use an anamorphic prism, for example. Specifically, the anamorphic prism includes a pair of prisms 31a and 31b, and is an optical element configured to emit a beam in a direction parallel to an incident beam after a magnification ratio of the outgoing beam to the incident beam is changed in a specific direction of the beam cross-section (i.e., compression or elongation). Hence, the anamorphic prism can cause a collimated beam with a diameter to pass through the anamorphic prism after only one direction of the beam is enlarged while the beam direction perpendicular to one direction is maintained the same.

Also, the anamorphic prism can be configured to change the magnification ratio a by about two to four times by changing angles and a distance between the two prisms 31a and 31b.

As described above, according to the oblique incidence interferometer 3 of the third embodiment, only the beam direction perpendicular to an incident direction is enlarged for irradiating the measurement object W therewith by causing a beam to pass through the beam diameter enlarging member 31, so that the same advantages as the advantages of the first and second embodiments can be obtained. Also, the configuration is simplified because it is not necessary to cause the optical component to be driven.

The embodiments of the present invention have been described above. However, the invention is not limited to these embodiments. Various modifications, additions, and substitutions can be made within the scope of the invention.

The measurement range enlarging means of the present invention may also be incorporated, for example, in a Mach-Zehnder oblique incidence interferometer.

What is claimed is:

1. An oblique incidence interferometer comprising:
a light source configured to emit coherent light in an oblique direction to a measurement object;
a light collimating unit configured to collimate the coherent light from the light source into a collimated beam;
a beam dividing unit configured to divide the collimated beam from the light collimating unit into a measurement beam and a reference beam, the reference beam being incident on the measurement object in a predetermined direction;
a beam combining unit configured to combine the measurement beam reflected by the measurement object with the reference beam;
an image pickup device configured to pick up images of interference fringes representing a surface shape of the measurement object from the beams combined by the beam combining unit; and
measurement range expanding means for enlarging a light measurement range of the measurement beam on the measurement object in a lateral direction of the measurement range, the lateral direction being orthogonal to the predetermined direction by which the measurement beam is incident on the measurement object.

2. The oblique incidence interferometer according to claim 1, wherein the measurement range expanding means comprises:
an optical path shift member arranged between the light collimating unit and the beam dividing unit, the optical path shift member moving a proceeding direction of the coherent light in the lateral direction by causing the coherent light from the light source to pass through the optical path shift member;
a drive unit configured to rotate the optical path shift member; and
a controller that causes the image pickup device to integrally receive images of interference fringes of an irradiation region, which moves in the lateral direction, for a period of time longer than a moving cycle of the optical path shift member by rotating the optical path shift member to move the irradiation region on the measurement object in the lateral direction of the irradiation region.

3. The oblique incidence interferometer according to claim 2, wherein the drive unit is configured to rotatively reciprocate the optical path shift member by a predetermined angle.

4. The oblique incidence interferometer according to claim 2, wherein the drive unit is configured to continuously rotate the optical path shift member in one direction.

5. The oblique incidence interferometer according to claim 4, further comprising a shutter configured to be opened/closed according to a rotation angle of the optical path shift member,
wherein the controller is configured to cause the image pickup device to selectively and integrally receive images of the interference fringes of the irradiation region by controlling the opening/closing of the shutter.

6. The oblique incidence interferometer according to claim 1, wherein the measurement range expanding means is a beam diameter enlarging member, which is arranged between the light collimating unit and the beam dividing unit, and causes the coherent light from the light source to pass through the beam diameter enlarging member to enlarge a diameter of the coherent light only in one direction.

7. The oblique incidence interferometer according to claim 6, wherein the beam diameter enlarging member is an anamorphic prism.

8. A method of measuring a surface of a measurement object using an oblique incidence interferometer, the method comprising:
emitting coherent light in an oblique direction to the measurement object;
collimating the coherent light into a collimated beam;
dividing the collimated beam into a measurement beam and a reference beam, the reference beam being incident on the measurement object in a predetermined direction;
combining the measurement beam reflected by the measurement object with the reference beam;
picking up images of interference fringes representing a surface shape of the measurement object from the combined beams; and
expanding a light measurement range of the measurement beam on the measurement object in a lateral direction of the light measurement range, the lateral direction being orthogonal to the predetermined direction by which the measurement beam is incident on the measurement object.

9. The method of claim 8, wherein the expanding step comprises:
passing the coherent light through a rotating optical path shift member;
moving a proceeding direction of the coherent light in the lateral direction with the rotating optical path shift member, to move an irradiation region on the measurement object in the lateral direction of the irradiation region; and
receiving images of interference fringes of the irradiation region, which moves in the lateral direction, for a period of time longer than a moving cycle of the rotating optical shift member.

10. The method of claim 9, further comprising:
rotating the rotating optical shift member by a predetermined angle.

11. The method of claim 9, further comprising:
rotating the rotating optical shift member continuously in one direction.

12. The method of claim 11, further comprising:
opening and closing a shutter according to a rotation angle of the optical path shift member; and
controlling the opening and closing of the shutter to selectively and integrally receive images of interference fringes of the irradiation region.

13. The method of claim 8, further comprising:
passing the coherent light through a beam diameter enlarging member to enlarge a diameter of the coherent light only in one direction.

14. The method of claim 8, further comprising:
passing the coherent light through an anamorphic prism to enlarge a diameter of the coherent light only in one direction.
